(19) United States
(12) Patent Application Publication
(10) Pub. No.: US 2026/0175581 A1
(43) Pub. Date: Jun. 25, 2026

(54) LIQUID EJECTION CHIP, LIQUID EJECTION HEAD, AND MANUFACTURING METHOD OF LIQUID EJECTION HEAD

(71) Applicant: CANON KABUSHIKI KAISHA, Tokyo (JP)

(72) Inventors: KOJI TACHIBANA, Kanagawa (JP); TAKUYA IWANO, Tokyo (JP); NAOYA TSUKAMOTO, Kanagawa (JP); AYAKO MARUYAMA, Kanagawa (JP)

(21) Appl. No.: 19/416,221

(22) Filed: Dec. 11, 2025

(30) Foreign Application Priority Data
Dec. 19, 2024 (JP) 2024-224002

(51) Int. Cl. B41J 2/16; B41J 2/14

(52) U.S. Cl. CPC B41J 2/1623; B41J 2/14233; B41J 2/1433; B41J 2/161; B41J 2002/14362; B41J 2002/14419; B41J 2002/14491

(57) ABSTRACT

A liquid ejection chip includes a first substrate and a second substrate. A first adhesive agent layer including a first adhesive agent and second adhesive agent layers including a second adhesive agent are provided on a bonding surface of the second substrate bonded to a liquid supply member. The second substrate includes projecting portions projecting in a first direction more than the first substrate in a state where the liquid ejection chip is seen from a direction perpendicular to the bonding surface. The second adhesive agent layers are provided at the projecting portions.

### BACKGROUND

### Field of the Technology

The present disclosure relates to a liquid ejection chip, a liquid ejection head, and a manufacturing method of a liquid ejection head.

### Description of the Related Art

In general, two or more kinds of adhesive agents may be used to attach a plurality of members constituting a liquid ejecting substrate that ejects a liquid.

Japanese Patent Laid-Open No. 2023-70494 discloses a liquid ejection head (liquid ejecting substrate) in which a first member and a second member that includes energy generating elements for generating energy to eject a liquid are attached with two or more kinds of adhesive agents. In the liquid ejection head according to Japanese Patent Laid-Open No. 2023-70494, a first adhesive agent is applied to a first projection of the first member, and a second adhesive agent is applied to a second projection of the first member. In the liquid ejection head according to Japanese Patent Laid-Open No. 2023-70494, the first projection and the second projection have mutually different heights. Therefore, even in a case where two or more kinds of adhesive agents are used, mixing of these adhesive agents is suppressed.

Incidentally, in the liquid ejection head according to Japanese Patent Laid-Open No. 2023-70494, physical property values of the first adhesive agent and physical property values of the second adhesive agent are different from each other. Therefore, resonance frequencies generated during a liquid ejecting operation are different from each other between a location where the first adhesive agent is applied and a location where the second adhesive agent is applied in the liquid ejection head according to Japanese Patent Laid-Open No. 2023-70494. In other words, there is a concern that the liquid ejection head according to Japanese Patent Laid-Open No. 2023-70494 may affect liquid ejection performance.

### SUMMARY

The present disclosure is to provide a liquid ejection head capable of suppressing degradation of liquid ejection performance.

A liquid ejection chip of the present disclosure includes: a first substrate in which nozzle configured to eject a liquid supplied from a liquid supply member configured to supply the liquid are formed; and a second substrate in which connection flow path connected to a supply flow path formed in the liquid supply member are formed, in which a first adhesive agent layer including a first adhesive agent and second adhesive agent layers including a second adhesive agent are provided on a bonding surface of the second substrate bonded to the liquid supply member, the second substrate includes projecting portions projecting in a first direction more than the first substrate in a state where the liquid ejection chip is seen from a direction perpendicular to the bonding surface, and the second adhesive agent layers are provided at the projecting portions.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic perspective view of a liquid ejection apparatus that can be applied to an embodiment;

FIG. 2 is a schematic perspective view of a liquid ejection head that can be applied to an embodiment;

FIG. 3 is a schematic perspective view of the liquid ejection head that can be applied to an embodiment;

FIG. 4 is a schematic exploded perspective view of the liquid ejection head that can be applied to an embodiment;

FIG. 5 is a schematic perspective view of a liquid ejection unit that can be applied to an embodiment;

FIG. 6 is a schematic perspective view of the liquid ejection unit that can be applied to an embodiment;

FIG. 7 is a schematic exploded perspective view of the liquid ejection unit that can be applied to an embodiment;

FIG. 8 is a schematic perspective view of an electric connecting portion that can be applied to an embodiment;

FIG. 9A is a schematic bottom view of a liquid ejection chip that can be applied to an embodiment;

FIG. 9B is a schematic plan view of the liquid ejection chip that can be applied to an embodiment;

FIG. 10A is a schematic sectional perspective view of the liquid ejection chip that can be applied to an embodiment;

FIG. 10B is an enlarged perspective view illustrating a part of FIG. 10A in an enlarged manner;

FIG. 11A is a schematic plan view of the liquid ejection chip in a state where adhesive agents that can be applied to an embodiment are applied thereto;

FIG. 11B is a schematic sectional view in a case where the liquid ejection unit is cut along an X-axis direction;

FIG. 12A is a diagram illustrating a liquid ejection chip and a liquid ejection unit in a comparative example;

FIG. 12B is a diagram illustrating a liquid ejection chip and a liquid ejection unit in a comparative example;

FIG. 13A is a diagram illustrating a liquid ejection chip and a liquid ejection unit in a comparative example;

FIG. 13B is a diagram illustrating a liquid ejection chip and a liquid ejection unit in a comparative example;

FIG. 14A is a graph showing simulation results of normal stresses generated in a liquid ejecting portion according to an embodiment;

FIG. 14B is a schematic bottom view of the liquid ejection chip that can be applied to an embodiment;

FIG. 15 is a flowchart illustrating a manufacturing method of a liquid ejection head that can be applied to an embodiment;

FIG. 16 is a schematic plan view of a liquid ejection chip in a state where adhesive agents that can be applied to an embodiment are applied thereto;

FIG. 17A is a graph showing simulation results of normal stresses generated in the liquid ejecting portion according to an embodiment; and

FIG. 17B is a schematic bottom view of the liquid ejection chip that can be applied to an embodiment.

### DESCRIPTION OF THE EMBODIMENTS

### First Embodiment

### Liquid Ejection Apparatus 10

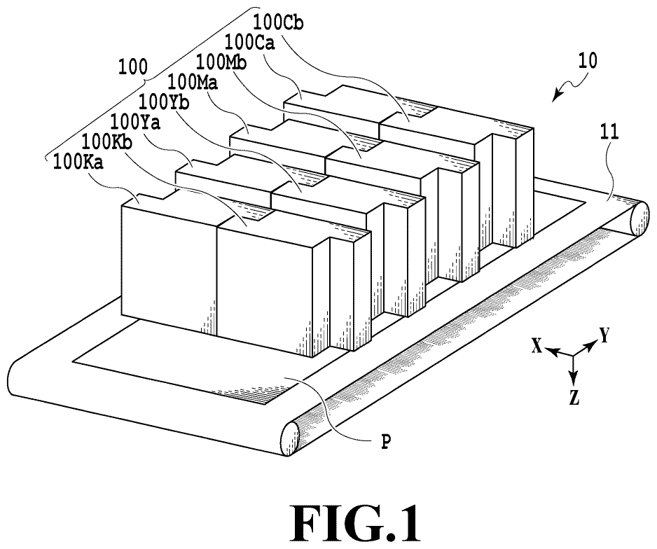

FIG. 1 is a schematic perspective view of a liquid ejection apparatus 10 that can be applied to a present embodiment.

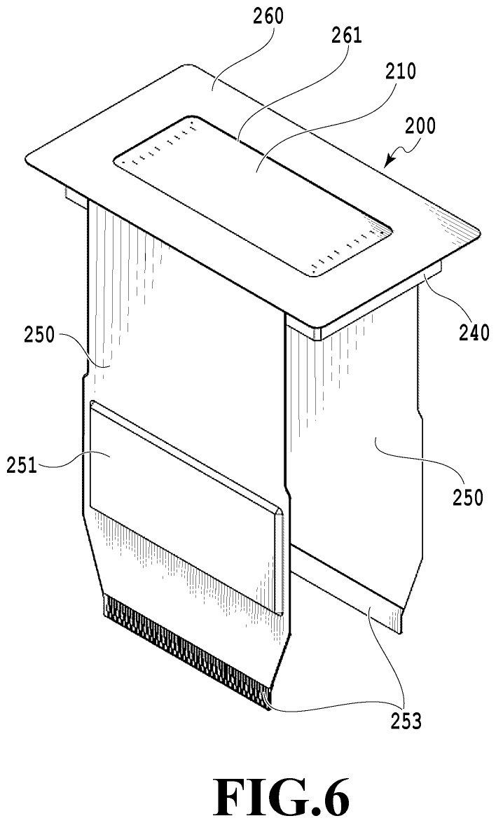

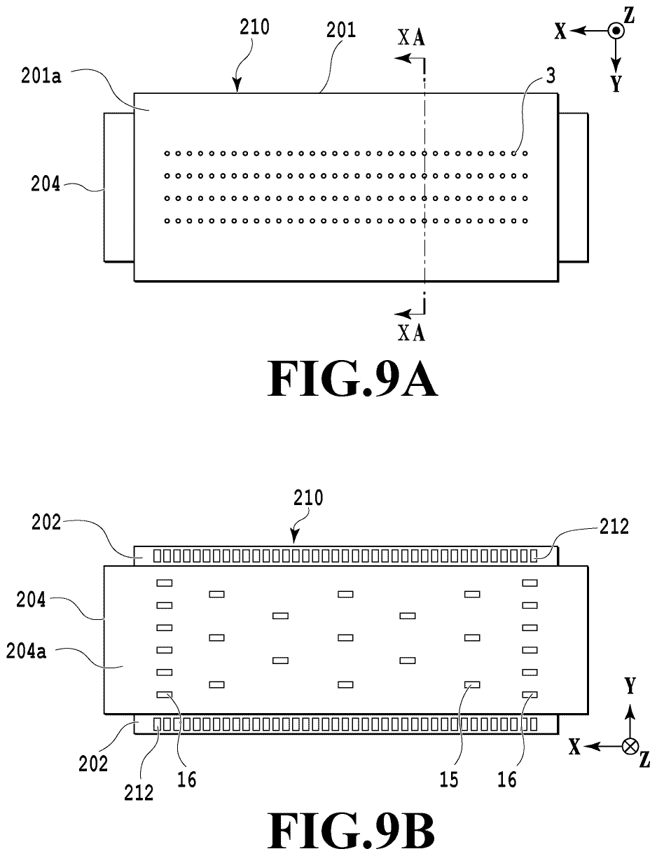

Z, X, and Y axes illustrated in each drawing referred to in the following description indicate coordinate axes in the liquid ejection apparatus 10. The Z axis indicates a first axis, the X-axis direction indicates a second axis, and Y indicates a third axis. These axes perpendicularly intersect each other. The Z-axis direction (first axis direction) indicates a liquid (ink, for example) ejection direction of a liquid ejection head 100. The X-axis direction (second axis direction) indicates an array direction of nozzles 3 (see FIGS. 9A and 9B and the like) in a liquid ejection chip 210 (see FIG. 6 and the like). The Y-axis direction (third axis direction) indicates a transporting direction of a printing medium P.

The liquid ejection apparatus 10 illustrated in FIG. 1 prints an image by ejecting a liquid (ink, for example) from the liquid ejection head 100 disposed at a specific position while successively transporting the printing medium P in the transporting direction by a conveying device 11. In this manner, an inkjet printing apparatus including a so-called full-line-type liquid ejection head 100 is used as the liquid ejection apparatus 10 in the present embodiment. The nozzle 3 (see FIGS. 9A, 9B, and the like) for ejecting a liquid (ink, for example) are formed on a side of the liquid ejection head 100 corresponding to the entire width (the length in the X-axis direction) of the printing medium P.

In the present embodiment, the liquid ejection head 100 deals with four colors, namely cyan (C), magenta (M), yellow (Y), and black (K). Specifically, the liquid ejection head 100 includes a first liquid ejection head 100Ca and a second liquid ejection head 100Cb corresponding to cyan (C) ink. The liquid ejection head 100 includes a third liquid ejection head 100Ma and a fourth liquid ejection head 100Mb corresponding to magenta (M) ink. The liquid ejection head 100 includes a fifth liquid ejection head 100Ya and a sixth liquid ejection head 100Yb corresponding to yellow (Y) ink. The liquid ejection head 100 includes a seventh liquid ejection head 100Ka and an eighth liquid ejection head 100Kb corresponding to black (K) ink.

The printing medium P is transported in the transport direction (−Y-axis direction) by the conveying device 11. The liquid ejection head 100 performs printing on the printing medium P.

Note that the liquid ejection apparatus 10 illustrated in FIG. 1 is just an example. The liquid ejection apparatus 10 can be configured such that the liquid ejection head 100 in an arbitrary form can be mounted thereon. For example, the liquid ejection head 100 may be configured to be able to eject only one kind of ink or may be configured to be able to eject more than the above-described four kinds of ink.

### Liquid Ejection Head 100

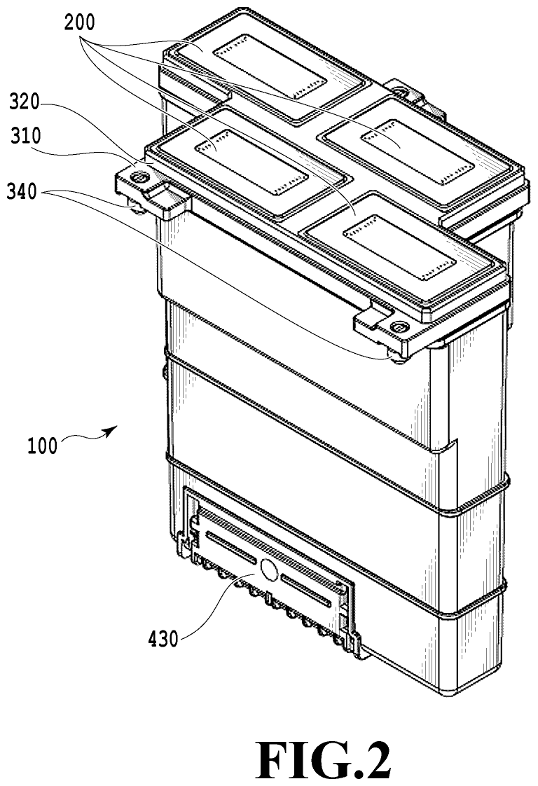

FIG. 2 is a schematic perspective view of the liquid ejection head 100 that can be applied to the present embodiment in a view from the bottom.

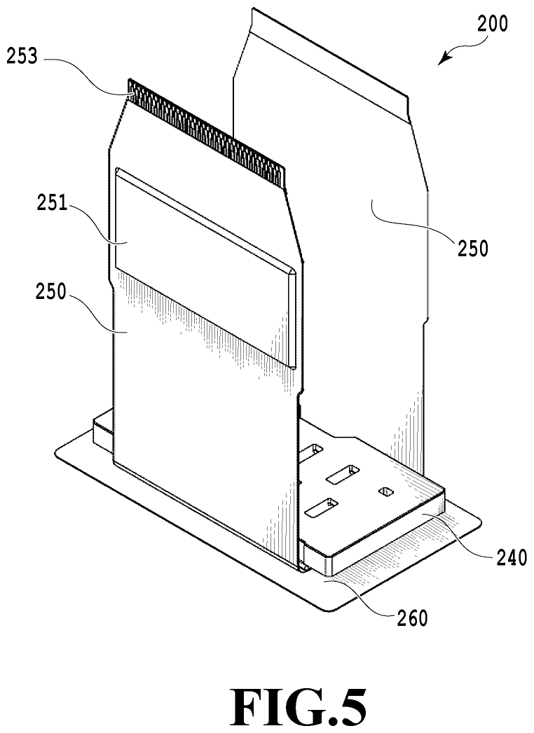

As illustrated in FIG. 2, four liquid ejection units 200 are aligned in a staggered pattern in a base member 310 in the liquid ejection head 100 of the present embodiment. A frame member 320 is bonded to the base member 310. The frame member 320 has a frame structure for supporting end portions of support members 260 (see FIG. 5 and the like). Reference members 340 are bonded to the base member 310. The liquid ejection head 100 is positioned with respect to the liquid ejection apparatus 10 (see FIG. 1) by the reference members 340.

In the present embodiment, the frame member 320 is formed such that one frame member 320 supports the plurality of support members 260. However, a plurality of frame members 320 that support the plurality of support members 260 in a divided manner may be formed.

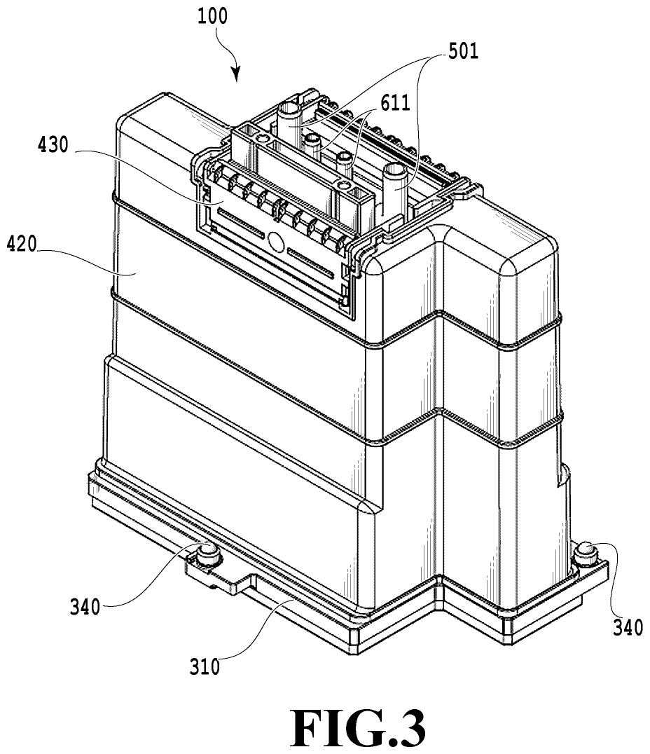

FIG. 3 is a schematic perspective view of the liquid ejection head 100 that can be applied to the present embodiment in a view from the top.

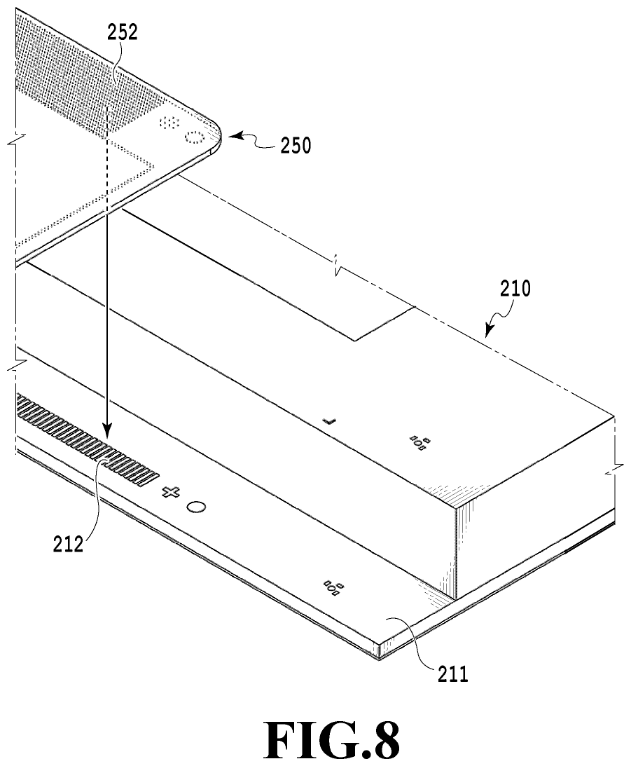

As illustrated in FIG. 3, an exterior portion of the liquid ejection head 100 is provided with a first cover member 420 for covering and protecting an electric substrate and a second cover member 430 for covering and protecting an electric connecting portion 252 (see FIG. 8). The exterior portion of the liquid ejection head 100 is provided with liquid connecting portions 501 for supplying a liquid to the inside of the liquid ejection head 100 and refrigerant connecting portions 611 for supplying a refrigerant to the inside of the liquid ejection head 100.

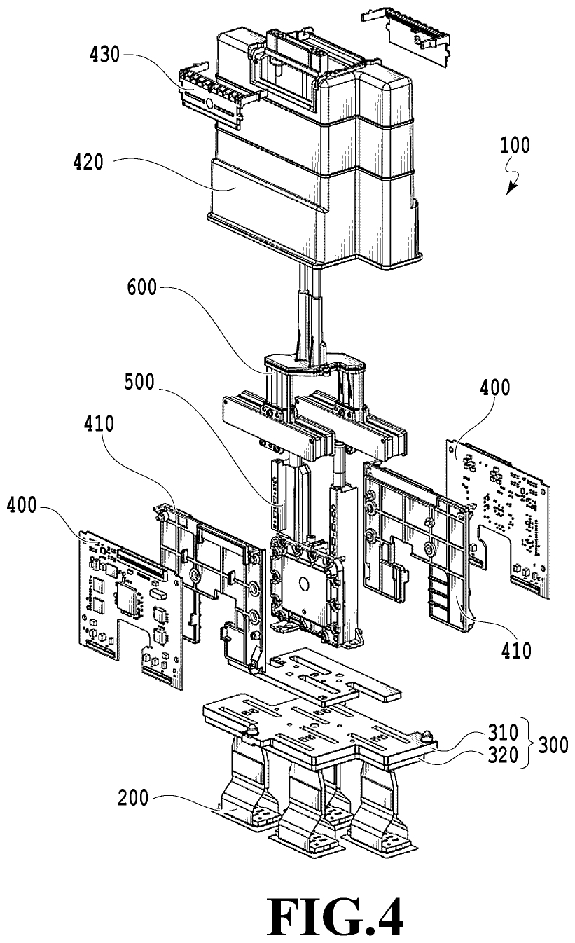

FIG. 4 is a schematic exploded perspective view of the liquid ejection head 100 that can be applied to the present embodiment.

As illustrated in FIG. 4, a base unit 300, an electric wiring substrate 400, a substrate holding member 410 that holds the electric wiring substrate 400, a liquid supply unit 500, and a cooling unit 600 are provided inside the liquid ejection head 100. The base unit 300 includes the base member 310 and the frame member 320. The liquid supply unit 500 supplies a liquid to the liquid ejection units 200 via the base unit 300. The cooling unit 600 cools a drive circuit.

### Liquid Ejection Unit 200

FIG. 5 is a schematic perspective view of each liquid ejection unit 200 that can be applied to the present embodiment in a view from the top.

As illustrated in FIG. 5, each liquid ejection unit 200 includes a liquid supply member 240 that supplies a liquid to the liquid ejection chip 210 (see FIG. 6 and the like) and a flexible wiring substrate 250 that has flexibility. Suitable examples that can be applied to the liquid supply member 240 include alumina, resin, and the like.

FIG. 6 is a schematic perspective view of the liquid ejection unit 200 that can be applied to the present embodiment in a view from the bottom.

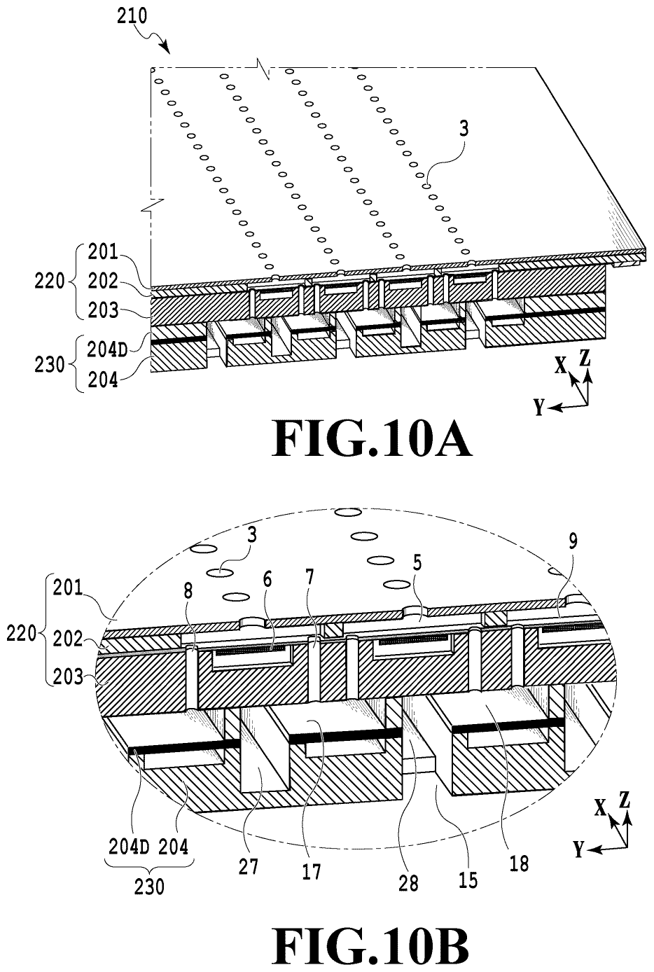

As illustrated in FIG. 6, the liquid ejection unit 200 includes the liquid ejection chip 210 that ejects a liquid and the flexible wiring substrate 250 that is electrically connected to the liquid ejection chip 210. The flexible wiring substrate 250 is provided with a drive circuit substrate 251 for driving energy generating elements 6 of the liquid ejection chip 210 (see FIG. 10B).

Also, the liquid ejection unit 200 includes the support members 260 bonded to a nozzle surface 201a (see FIG. 9A) of the liquid ejection chip 210. It is desirable that the thickness of the support members 260 be equal to or less than 300 μm. A narrower gap between the nozzle surface 201a (see FIG. 9A) and the printing medium P (see FIG. 1) can further suppress image distortion.

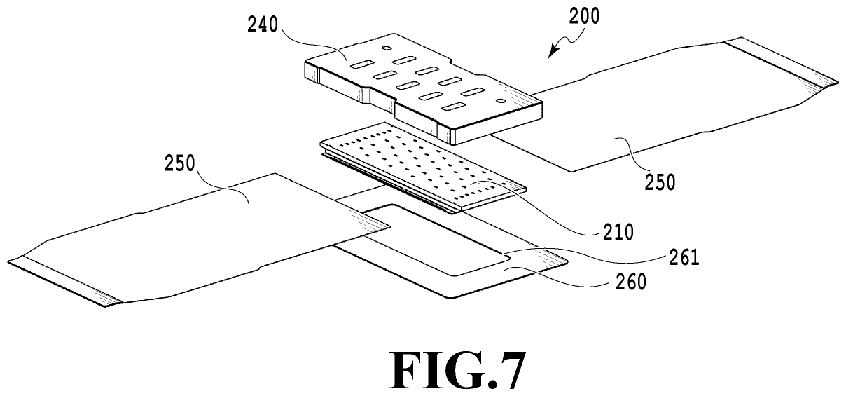

FIG. 7 is a schematic exploded perspective view of the liquid ejection unit 200 that can be applied to the present embodiment.

As illustrated in FIG. 7, each support members 260 includes an opening 261 for enabling a liquid to be ejected from the nozzles 3 (see FIG. 9A).

### Electric Connecting Portion 252

FIG. 8 is a schematic perspective view of the electric connecting portion 252 that can be applied to the present embodiment.

As illustrated in FIG. 8, thin plate portions 211 are provided at both end portions of the liquid ejection chip 210. The thin plate portions 211 are provided with an electrode portion 212. The flexible wiring substrate 250 is electrically connected to the liquid ejection chip 210 by bringing electrodes at the electric connecting portion 252 of the flexible wiring substrate 250 and at the electrode portion 212 into contact with each other. The support member 260 (see FIG. 5 and the like) is bonded to the nozzle surface 201a (see FIG. 9A) to suppress entrance of a liquid into the electric connecting portion 252 and protect the liquid ejection chip 210.

### Liquid Ejection Chip 210

FIG. 9A is a schematic bottom view of the liquid ejection chip 210 that can be applied to the present embodiment.

As illustrated in FIG. 9A, the liquid ejection chip 210 includes a flow path formation substrate 204 and a nozzle substrate 201. The nozzle substrate 201 includes the nozzle surface 201a in which the nozzles 3 are formed. A bottom surface (nozzle surface 201a) of the liquid ejection chip 210 is formed in the nozzle substrate 201. One nozzle array formed by the plurality of nozzles 3 for ejecting a liquid being aligned in a longitudinal direction (X-axis direction) of the nozzle substrate 201 is configured in the nozzle surface 201a. In the present embodiment, a plurality of nozzle arrays are provided in parallel in the Y-axis direction.

In order to suppress solidification of the liquid, water repellency treatment is performed on the nozzle surface 201a. However, it is desirable that the water-repellent coating be removed in a region of the nozzle surface 201a to be attached to the support member 260 in order to improve an adhesive force of an adhesive agent.

FIG. 9B is a schematic plan view of the liquid ejection chip 210 that can be applied to the present embodiment.

As illustrated in FIG. 9B, the flow path formation substrate 204 includes a bonding surface 204a. A connection flow path 15 for supplying and collecting a liquid to and from the liquid ejection chip 210 is formed in the flow path formation substrate 204. An atmosphere communication opening 16 that causes the liquid ejection chip 210 to communicate with air is formed in the flow path formation substrate 204.

The connection flow path 15 communicate with the liquid connecting portions 501 (see FIG. 3) via the liquid supply unit 500 (see FIG. 4). The liquid connecting portions 501 are connected to an external liquid tank (not illustrated). In this manner, the liquid supplied from the liquid tank is supplied to the inside of the liquid ejection chip 210 via the liquid connecting portions 501 and the connection flow paths 15.

### Internal Structure of Liquid Ejection Chip 210

FIG. 10A is a schematic sectional perspective view of the liquid ejection chip 210 that can be applied to the present embodiment. Note that FIG. 10A illustrates a section of the liquid ejection chip 210 cut along the line XA-XA in FIG. 9A.

As illustrated in FIG. 10A, the liquid ejection chip 210 includes a first substrate 220 and a second substrate 230. The first substrate 220 includes the nozzle substrate 201, a liquid chamber substrate 202, and a liquid supply substrate 203. The first substrate 220 is configured by the liquid supply substrate 203, the liquid chamber substrate 202, and the nozzle substrate 201 being laminated in this order.

The second substrate 230 includes the flow path formation substrate 204 including a damper film 204D with elasticity. A pressure varies inside pressure chambers 5 formed in the first substrate 220 including the liquid supply substrate 203 fixed to the flow path formation substrate 204 at the time of liquid ejection. However, it is possible to suppress transmission of the pressure variations to other pressure chambers by the damper film 204D being deformed by the pressure variations generated inside the pressure chambers 5. The liquid ejection chip 210 is configured by the second substrate 230 and the first substrate 220 being laminated in this order.

FIG. 10B is an enlarged perspective view illustrating a part of FIG. 10A in an enlarged manner.

As illustrated in FIG. 10B, the liquid chamber substrate 202 includes a vibrating plate 9 with elasticity in the first substrate 220. The pressure chambers 5 connected to the nozzles 3 are formed between the nozzle substrate 201 and the liquid supply substrate 203 in a state where the liquid supply substrate 203, the liquid chamber substrate 202, and the nozzle substrate 201 are laminated in this order. In each of the plurality of pressure chambers 5, the vibrating plate 9 constituting a part of the liquid chamber substrate 202 functions as a deformable wall portion.

The pressure chambers 5 function as flow paths connected to the nozzles 3. It is desirable that the height (the length in the Z-axis direction) of the flow paths formed by the pressure chambers 5 and the nozzles 3 be equal to or less than 300 μm. It is possible to exhibit relatively high ejection performance and circulation performance by thinning the flow paths in this manner. Therefore, it is desirable that the total value of the thickness of the nozzle substrate 201 constituting a part of the flow paths and the thickness of the liquid chamber substrate 202 be equal to or less than 300 μm.

The vibrating plate 9 includes a plurality of energy generating elements 6 for generating energy to eject the liquid such that the energy generating elements 6 correspond to a plurality of liquid chambers, respectively.

In the present embodiment, piezoelectric elements are used as the energy generating elements 6. The energy generating elements 6 are provided at positions corresponding to the plurality of nozzles 3, respectively. The vibrating plate 9 is deformed by the energy generating elements 6 receiving power to eject the liquid and being driven. The liquid with which the inside of the pressure chambers 5 are filled is pressurized by the vibrating plate 9 being deformed. The liquid is ejected from the nozzles 3 by the liquid with which the inside of the pressure chambers 5 are filled being pressurized.

The liquid supply substrate 203 is bonded to the surface of the liquid chamber substrate 202 on the side opposite to the surface bonded to the nozzle substrate 201. Individual supply flow paths 7 for supplying the liquid to the pressure chambers 5 and individual collection flow paths 8 for collecting the liquid from the pressure chambers 5 are formed in the liquid supply substrate 203. The individual supply flow paths 7 and the individual collection flow paths 8 are connected to the pressure chambers 5 in a state where the liquid supply substrate 203, the liquid chamber substrate 202, and the nozzle substrate 201 are laminated in this order. A material constituting each of the nozzle substrate 201, the liquid chamber substrate 202, the liquid supply substrate 203, and the flow path formation substrate 204 includes silicon or the like.

In the present embodiment, these substrates are individually formed. However, these substrates may be integrally formed.

In the second substrate 230, the connection flow paths 15, a common supply flow path 27, a common supply communication path 17, a common collection communication path 18, and a common collection flow path 28 are formed in the flow path formation substrate 204. The common supply flow path 27 is connected to the common supply communication path 17. One common supply communication path 17 is connected to the plurality of individual supply flow paths 7 in a state where the second substrate 230 and the first substrate 220 are laminated in this order.

The plurality of individual collection flow paths 8 are connected to one common collection communication path 18 in the state where the second substrate 230 and the first substrate 220 are laminated in this order. The common collection communication path 18 is connected to the common collection flow path 28. The liquid flowing from the liquid tank (not illustrated) into the common supply flow path 27 through the connection flow paths 15 flows into the individual supply flow paths 7 via the common supply communication path 17 and is then supplied to the pressure chambers 5.

The liquid supplied to the pressure chambers 5 is ejected from the nozzles 3 by the energy generating elements 6 being driven. The liquid that has not been ejected flows into the individual collection flow paths 8.

Also, in a case where the energy generating elements 6 are not driven (for example, in a case where circulation for adjusting the temperature of the liquid is performed), the entire liquid that has been supplied to the pressure chambers 5 flows into the individual collection flow paths 8. The liquid that has flowed into the individual collection flow paths 8 flows into the common collection flow path 28 via the common collection communication path 18 and is then collected in the liquid tank (not illustrated) via the connection flow paths 15.

### First Adhesive Agent 701 and Second Adhesive Agent 702

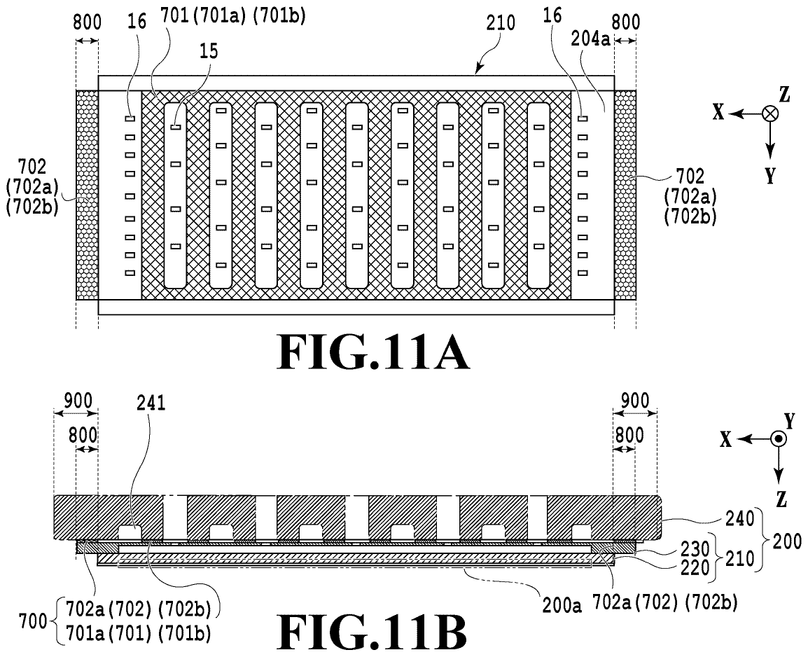

FIG. 11A is a schematic plan view of the liquid ejection chip 210 in a state where adhesive agents that can be applied to the present embodiment are applied thereto.

As illustrated in FIG. 11A, a first adhesive agent 701 and a second adhesive agent 702 are applied to the bonding surface 204a of the liquid ejection chip 210 in plan view of the liquid ejection chip 210. Physical property values of the first adhesive agent 701 and physical property values of the second adhesive agent 702 are different from each other. Examples of the physical property values include coefficients of linear expansion, elastic coefficients, and the like.

For example, the coefficient of linear expansion of the first adhesive agent 701 is 1.2 times the coefficient of linear expansion of the second adhesive agent 702. The elastic coefficient of the first adhesive agent 701 is 1.2 times the elastic coefficient of the second adhesive agent 702. Alternatively, the coefficient of linear expansion of the second adhesive agent 702 may be 1.2 times the coefficient of linear expansion of the first adhesive agent 701. The elastic coefficient of the second adhesive agent 702 may be 1.2 times the elastic coefficient of the first adhesive agent 701.

The first adhesive agent 701 is applied to the periphery of a one connection flow path array formed by the plurality of connection flow paths 15 being aligned in a transverse direction (Y-axis direction). It is thus possible to supply the liquid from the liquid supply member 240 (see FIG. 11B and the like) to the liquid ejection chip 210 while suppressing leakage of the liquid. Since the first adhesive agent 701 is applied to the part near the connection flow paths 15 through which the liquid flows, the first adhesive agent 701 preferably has liquid resistance (for example, chemical resistance against ink).

On the other hand, the second adhesive agent 702 is applied to both end portions of the liquid ejection chip 210 in the longitudinal direction (X-axis direction).

In the present embodiment, the second substrate 230 includes first projecting portions 800 that project outward from end portions of the first substrate 220 in the longitudinal direction (X-axis direction) in a state where the second substrate 230 is laminated on the first substrate 220. The second adhesive agent 702 is applied only to the first projecting portions 800.

A timing at which the first adhesive agent 701 is cured and a timing at which the second adhesive agent 702 are cured are different from each other. The second adhesive agent 702 is cured earlier than the first adhesive agent 701. For example, the second adhesive agent 702 is cured at a normal temperature, and the first adhesive agent 701 is cured at a temperature that is higher than the normal temperature. According to the configuration, it is possible to temporarily fix the liquid ejection chip 210 to the liquid supply member 240 by curing the second adhesive agent 702 earlier than the first adhesive agent 701 at the time of thermosetting processing for fixing the liquid ejection chip 210 to the liquid supply member 240.

Then, the first adhesive agent 701 is cured in a state where the liquid ejection chip 210 is temporarily fixed to the liquid supply member 240, thereby fixing the liquid ejection chip 210 to the liquid supply member 240 while suppressing positional deviation of the liquid ejection chip 210.

Examples of the first adhesive agent 701 that can be applied to the present embodiment include a thermosetting adhesive agent. However, examples of the first adhesive agent 701 are not limited thereto as long as it has liquid resistance against a liquid to be used.

Examples of the second adhesive agent 702 that can be applied to the present embodiment include a thermosetting adhesive agent, a UV-curable adhesive agent, a two-component-mixed adhesive agent, and an anaerobic curing adhesive agent. Examples of the second adhesive agent 702 are not limited thereto as long as the second adhesive agent 702 can be cured before the first adhesive agent 701 is cured.

It is possible to reduce the concern that the liquid adheres to the second adhesive agent 702 by surrounding the periphery of the connection flow paths 15 by the first adhesive agent 701 and applying the second adhesive agent 702 at a position separated from the connection flow paths 15 as in the present embodiment.

FIG. 11B is a schematic sectional view in a case where the liquid ejection unit 200 is cut in the X-axis direction.

As illustrated in FIG. 11B, the liquid ejection chip 210 includes the first substrate 220 and the second substrate 230. The nozzles 3 (see FIG. 10A and the like) for ejecting the liquid supplied from the liquid supply member 240 to supply the liquid are formed in the first substrate 220. The connection flow paths 15 (see FIG. 11A and the like) connected to a supply flow path 241 formed on the liquid supply member 240 are formed in the second substrate 230.

A first adhesive agent layer 701a including the first adhesive agent 701 and second adhesive agent layers 702a including the second adhesive agent 702 are provided on a bonding surface of the second substrate 230 bonded to the liquid supply member 240. The second substrate 230 includes the first projecting portions 800 that project in the first direction (X-axis direction) relative to the first substrate 220 in a view of the liquid ejection chip 210 seen from a direction perpendicular to the bonding surface of the second substrate 230 bonded to the liquid supply member 240. The second adhesive agent layers 702a are provided at the first projecting portions 800.

The bonding surface 204a (see FIG. 11A and the like) of the liquid ejection chip 210 bonded to the liquid supply member 240 includes a first region 701b where the first adhesive agent layer 701a including the first adhesive agent 701 is provided. The bonding surface 204a includes second regions 702b where the second adhesive agent layers 702a including the second adhesive agent 702, which has a coefficient of linear expansion that is different from the coefficient of linear expansion of the first adhesive agent 701, are provided.

In the posture in which the liquid ejection chip 210, the second regions 702b are provided at end portions (first projecting portions 800) of the bonding surface 204a in the first direction and are not provided immediately above the connection flow paths 15 and a liquid ejecting portion 200a including the plurality of nozzles 3.

Specifically, an adhesive agent layer 700 including the adhesive agents in a cured state is provided between the liquid ejection chip 210 and the liquid supply member 240 in a sectional view of the liquid ejection unit 200. The adhesive agent layer 700 includes the first adhesive agent layer 701a including the first adhesive agent 701 in the cured state and the second adhesive agent layers 702a including the second adhesive agent 702 in the cured state. The liquid supply member 240 includes second projecting portions 900 that project outward from the end portions of the first substrate 220 in the longitudinal direction (X-axis direction) in a sectional view of the liquid ejection unit 200.

The liquid ejection unit 200 includes the liquid ejecting portion 200a including the plurality of nozzles 3 (see FIG. 9A and the like). The length of the liquid ejecting portion 200a in the X-axis direction is substantially the same as the length of the nozzle arrays in the X-axis direction. The first adhesive agent layer 701a is provided on the side further inward than the liquid ejecting portion 200a in the X-axis direction.

The second adhesive agent layers 702a are provided only at the first projecting portions 800 on the side further outward than the liquid ejecting portion 200a.

It is desirable that the amount of projection of the first projecting portions 800 be equal to or greater than ½ times and less than 1 time the amount of projection of the second projecting portions 900.

For example, a ratio of coefficients of linear expansion between the first adhesive agent layer 701a and the second adhesive agent layers 702a after thermosetting may satisfy (Equation 1) below.
(Equation 1) . . . Coefficient of linear expansion of first adhesive agent layer 701 a: coefficient of linear expansion of second adhesive agent layers 702a=1:3

For example, the ratio of elastic coefficients between the first adhesive agent layer 701a and the second adhesive agent layers 702a after the thermosetting may satisfy (Equation 2) below.
(Equation 2) . . . Elastic coefficient of first adhesive agent layer 701 a: elastic coefficient of second adhesive agent layers 702 a=10:7

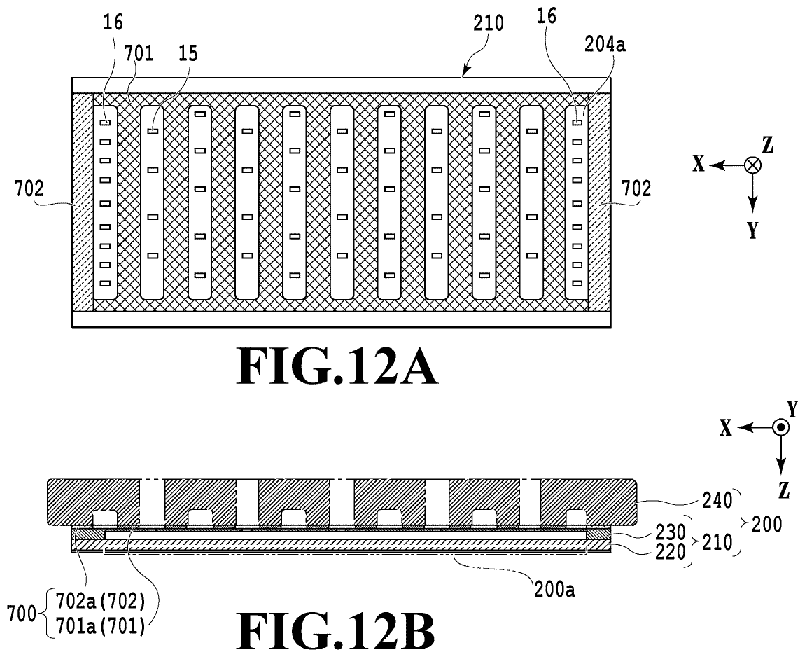

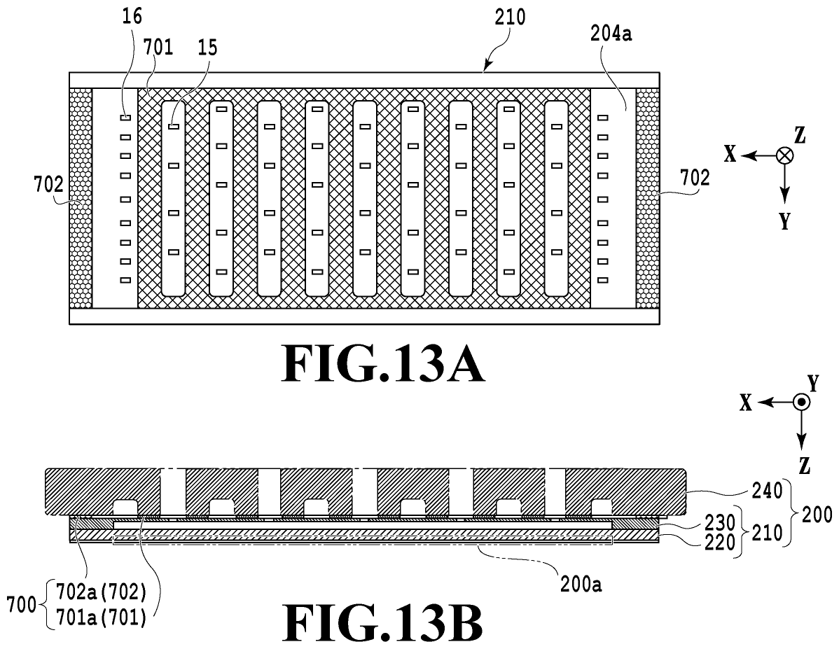

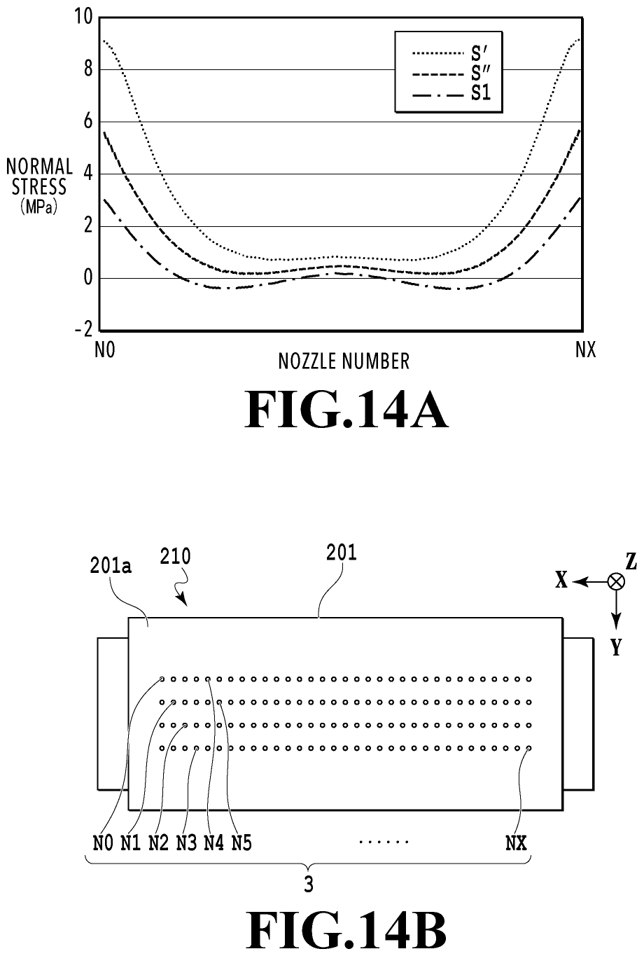

FIG. 14A is a graph showing simulation results of normal stresses generated in the liquid ejecting portion 200a of the present embodiment. In FIG. 14A, the one-dotted chain line of S1 indicates a simulation result of a normal stress generated in the liquid ejecting portion 200a (see FIG. 11B) in the present embodiment. The dotted line of S′ indicates a simulation result of a normal stress generated at a liquid ejecting portion 200a (see FIG. 12B) in a first comparative example. The dashed line of S″ indicates a simulation result of a normal stress generated at a liquid ejecting portion 200a (see FIG. 13(b)) in a second comparative example.

FIG. 14B is a schematic bottom view of the liquid ejection chip 210 that can be applied to the present embodiment. In FIG. 14B, “N0” to “NX” indicates the numbers of the plurality of nozzles 3, respectively.

In the present embodiment, the nozzle number of the nozzle 3 located at the uppermost and leftmost position in a bottom view of the liquid ejection chip 210 is “N0”. The nozzle number of the nozzle 3 located right next to and immediately below the nozzle 3 with the nozzle number “N0” is “N1”. The nozzle number of the nozzle located right next to and immediately below the nozzle 3 with the nozzle number “N1” is “N2”. The nozzle number of the nozzle 3 located right next to and immediately below the nozzle 3 with the nozzle number “N2” is “N3”. The nozzle number of the fourth nozzle 3 from the nozzle 3 with the nozzle number “N0” in the-X direction is “N4”. The nozzle number of the nozzle 3 located right next to and immediately below the nozzle 3 with the nozzle number “N4” is “N5”. Thereafter, the nozzle numbers are applied in order as described above.

In FIG. 14A, the horizontal axis of the graph corresponds to each of the plurality of nozzle numbers illustrated in FIG. 14B.

On the other hand, the vertical axis of the graph indicate a moving average of normal stresses applied at a total of four locations of the corresponding nozzle and nozzles up to the third nozzle from the corresponding nozzle generated in the liquid ejecting portion 200a in each of the present embodiment, the first comparative example, and the second comparative example.

Note that in the present embodiment, the “normal stress” means a stress generated in the X-axis direction perpendicular to the Z-axis direction.

As described above using FIGS. 11A and 11B, the materials of the first adhesive agent 701 and the second adhesive agent 702 (see FIG. 11A) are different from each other. In a case where the first adhesive agent 701 and the second adhesive agent 702 are thermosetting adhesive agents, it is necessary to lower the temperatures of the first adhesive agent layer 701a and the second adhesive agent layers 702a (see FIG. 11B) after the first adhesive agent 701 and the second adhesive agent 702 are cured.

While the temperatures of the first adhesive agent layer 701a and the second adhesive agent layers 702a are lowered, the first adhesive agent layer 701a and the second adhesive agent layers 702a contract due to the temperature change. Due to the contraction, a normal stress is generated at the interfaces (boundaries) of the first adhesive agent layer 701a and the second adhesive agent layers 702a.

Also, there is a trend that the normal stress generated in the first adhesive agent layer 701a and the second adhesive agent layers 702a is transmitted toward the nozzle surface 201a of the liquid ejection chip 210. This is because the liquid ejection chip 210 includes a material (for example, silicon) with relatively high rigidity and it is thus difficult to absorb or release a received force. In this manner, the normal stress generated at the attachment interface between the liquid ejection chip 210 and the liquid supply member 240 and the normal stress transmitted to the nozzle surface 201a are correlated.

As illustrated in FIGS. 14A and 14B, there is a trend that the normal stress values at the both end portions of the liquid ejecting portion 200a in the X-axis direction are larger than the normal stress value at the center portion of the liquid ejecting portion 200a in the X-axis direction.

As illustrated in FIGS. 12A and 12B, the length of a first substrate 220 in the X-axis direction and the length of a second substrate 230 in the X-axis direction are the same in the first comparative example. In other words, first projecting portions are not provided. Therefore, occurrence of a difference in normal stresses in an adhesive agent layer 700 leads to an increase in difference between normal stress values at both end portions of the liquid ejecting portion 200a in the X axis direction and a normal stress value at the center portion of the liquid ejecting portion 200a in the X-axis direction.

In the examples illustrated in FIG. 14A, the value of the normal stress acting on the liquid ejecting portion 200a is the largest in the configuration of the first comparative example. Therefore, it is difficult to stably eject a liquid by the configuration of the first comparative example.

As illustrated in FIGS. 13A and 13B, the distances of an interface between a first adhesive agent 701 and a second adhesive agent 702 from the liquid ejecting portion 200a are larger in the second comparative example than in the first comparative example.

However, the length of a first substrate 220 in the X-axis direction and the length of a second substrate 230 in the X-axis direction are the same. In other words, first projecting portions are not provided. Therefore, occurrence of a normal stress in an adhesive agent layer 700 leads to a larger difference between normal stress values at both end portions of the liquid ejecting portion 200a in the X-axis direction and a normal stress value at the center portion of the liquid ejecting portion 200a in the X-axis direction than that in the present embodiment.

In the examples illustrated in FIG. 14A, the value of the normal stress acting on the liquid ejecting portion 200a is the second largest in the configuration of the second comparative example. Therefore, it is difficult to stably eject a liquid by the configuration of the second comparative example.

As illustrated in FIGS. 11A and 11B, the interface of the first adhesive agent 701 and the second adhesive agent 702 is provided to have a long distance from the liquid ejecting portion 200a in the present embodiment similarly to the second comparative example. Also, the length of the second substrate 230 in the X-axis direction is longer than the length of the first substrate 220 in the X-axis direction.

The second adhesive agent layers 702a are provided at the first projecting portions 800 where the second substrate 230 projects from the both end portions of the first substrate 220 in the state where the first substrate 220 and the second substrate 230 are bonded. With this configuration, the liquid ejecting portion 200a is not located immediately below the second adhesive agent layers 702a, and the normal stress is less likely to be transmitted to the nozzles 3 if the normal stress is generated in the second adhesive agent layers 702a.

Note that the normal stress is less likely to be transmitted not only to the nozzles 3 but also to the vibrating plates 9 (see FIG. 10B) in the present embodiment.

As illustrated in FIG. 14A, variations in the normal stress value in the present embodiment is smaller than variations in normal stress value in the first comparative example and variations in normal stress value in the second comparative example.

Therefore, it is possible to ascertain that liquid ejection performance of the liquid ejection chip 210 is more stable in the present embodiment than in the first comparative example and the second comparative example.

### Manufacturing Method

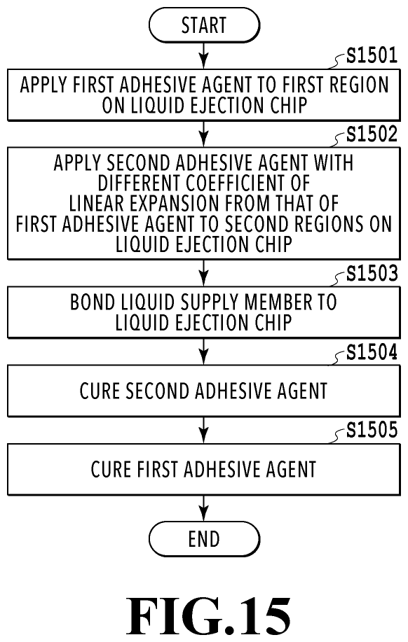

FIG. 15 is a flowchart illustrating a manufacturing method of the liquid ejection head 100 that can be applied to the present embodiment. The symbol “S” in FIG. 15 indicates each step. Note that FIG. 15 illustrates only characteristic processes of the technology of the present disclosure. Known methods are used for other processes.

In S1501, the first adhesive agent 701 is applied to the first region 701b on the bonding surface 204a of the liquid ejection chip 210 as described above using FIG. 11A.

In S1502, the second adhesive agent 702 with a different coefficient of linear expansion from that of the first adhesive agent 701 is applied to second regions 702b on the bonding surface 204a of the liquid ejection chip 210 as described above using FIG. 11A. In other words, the second adhesive agent 702 is applied to the first projecting portions 800 where the bonding surface of the second substrate 230 bonded to the liquid supply member 240 projects in the first direction more than the first substrate 220 (X-axis direction).

In S1503, the liquid ejection chip 210 is bonded to the liquid supply member 240 such that the connection flow paths 15 formed in the liquid ejection chip 210 are connected to the supply flow path 241 formed in the liquid supply member 240.

In S1504, the second adhesive agent 702 is cured in the state where the liquid ejection chip 210 is bonded to the liquid supply member 240.

In S1505, the first adhesive agent 701 is cured in the state where the liquid ejection chip 210 is bonded to the liquid supply member 240.

The manufacturing method of the liquid ejection head 100 has been described hitherto.

The order of S1501 and S1502 may be opposite at the time of performing the above-described processes. Although the order of S1504 and S1505 may be opposite, it is desirable that S1504 be performed earlier than S1505. This is because it is possible to fix the liquid ejection chip 210 to the liquid supply member 240 in a state where the liquid ejection chip 210 is temporarily fixed to the liquid supply member 240 according to the method.

In a case where the first adhesive agent 701 and the second adhesive agent 702 are thermosetting adhesive agents, for example, it is preferable to use the second adhesive agent 702 that is cured at a temperature that is equal to or higher than the normal temperature and to use the first adhesive agent 701 that is cured at a temperature that is higher than the temperature at which the second adhesive agent 702 is cured. In this manner, S1504 and S1505 can be performed together as one heating process of heating the entire chip. In the heating process, the second adhesive agent is cured earlier once a predetermined temperature (first temperature) is reached, and the first adhesive agent is then cured once a second temperature that is higher than the first temperature is reached. Alternatively, in a case where the second adhesive agent 702 is a UV curable adhesive agent, it is preferable to cure the second adhesive agent 702 by irradiating the second adhesive agent 702 with UV light before the first adhesive agent 701 is cured.

According to the method, it is possible to suppress positional deviation of the liquid ejection chip 210 during fixation of the liquid ejection chip 210.

As described above, the first adhesive agent 701 and the second adhesive agent 702 are applied to the bonding surface 204a of the liquid ejection chip 210 bonded to the liquid supply member 240 in the present embodiment. It is possible to achieve fixation in a state where the liquid ejection chip 210 is temporarily fixed to the liquid supply member 240 by curing the second adhesive agent 702 earlier than the first adhesive agent 701.

On the other hand, the coefficient of linear expansion of the first adhesive agent 701 is different from the coefficient of linear expansion of the second adhesive agent 702. Therefore, there is a concern that once the first adhesive agent layer 701a of the cured first adhesive agent 701 and the second adhesive agent layers 702a of the cured second adhesive agent 702 expand, the liquid ejection chip 210 may be damaged due to a difference in normal stresses acting on them.

Thus, the first adhesive agent 701 and the second adhesive agent 702 that minimize the mutual difference in normal stresses are used in the present embodiment. In this manner, it is possible to reduce the concern that the liquid ejection chip 210 may be damaged due to the difference in normal stresses of the first adhesive agent 701 and the second adhesive agent 702.

Additionally, there is a trend that the normal stresses generated in the first adhesive agent layer 701a and the second adhesive agent layers 702a act on parts located immediately below. However, the second adhesive agent layers 702a are located at the first projecting portions 800 of the second substrate 230 projecting further outward than the first substrate 220 in which the energy generating elements 6, the nozzles 3, and the like are provided in the present embodiment. In other words, the second adhesive agent layers 702a are not provided immediately above the energy generating elements 6, the nozzles 3, and the like in the posture in which the liquid ejection chip 210 is used.

Therefore, even if a normal stress is generated in the second adhesive agent layers 702a, it is still possible to reduce the influences on the liquid ejection since the energy generating elements 6, the nozzles 3, and the like are not present immediately below the second adhesive agent layers 702a.

Therefore, according to the liquid ejection chip of the present embodiment, it is possible to suppress degradation of liquid ejection performance.

### Second Embodiment

An object of the present embodiment is to provide a liquid ejection chip 210 capable of further suppressing degradation of liquid ejection performance than the first embodiment. In the following description, configurations that are similar or corresponding to those in the first embodiment will be denoted by the same reference signs, description thereof will be omitted, and different points will be mainly described.

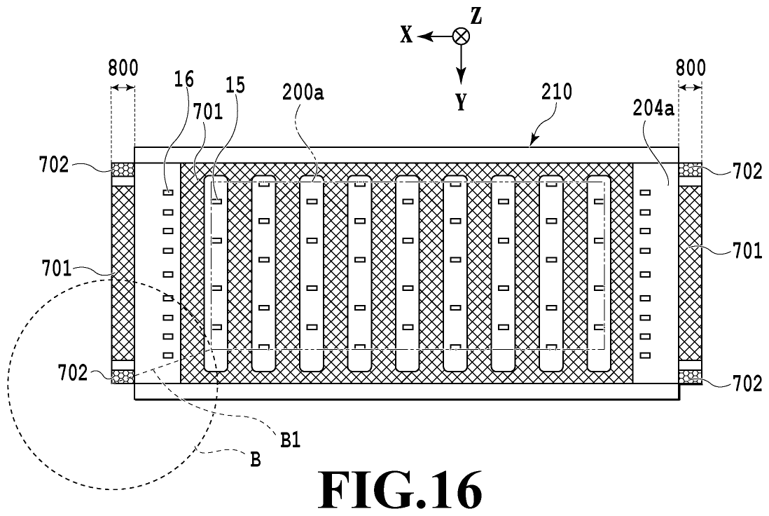

FIG. 16 is a schematic plan view of the liquid ejection chip 210 in a state where adhesive agents that can be applied to the present embodiment are applied thereto.

As illustrated in FIG. 16, a second adhesive agent 702 is applied within a range inside a virtual circle B having, as a radius, a virtual straight line B1 connecting a corner of each first projecting portion 800 to a corner of a liquid ejecting portion 200a that is the closest to the corner in a plan view of the liquid ejection chip 210 in the present embodiment. In other words, it is desirable that the second adhesive agent 702 be applied only to both end portions of the first projecting portions 800 in the Y direction.

In this case, once the second adhesive agent 702 is cured, each second adhesive agent layer 702a is provided inside the virtual circle B2 having, as a radius, the virtual straight line B1 connecting the corner of the first projecting portion 800 to a nozzle 3 that is the closest to the corner in a plan view of the liquid ejection chip 210.

In the present embodiment, the second adhesive agent layers 702a are provided only at the both end portions of the first projecting portions 800 in the Y direction. The first adhesive agent 701 is applied to the center portions of the first projecting portions 800 in the Y direction. Therefore, once the first adhesive agent 701 and the second adhesive agent 702 are cured, the second adhesive agent layers 702a are provided only at the periphery of the four corners of the bonding surface 204a in the present embodiment.

Also, the first adhesive agent layers 701a are provided at the center portion of the bonding surface 204a and the center portions of the first projecting portions 800. According to the configuration, the area in which the second adhesive agent 702 is applied decreases as compared with the first embodiment. Therefore, it is possible to further reduce a difference between the normal stress value of the first adhesive agent layers 701a and the normal stress value of the second adhesive agent layers 702a at an attachment interface between the liquid ejection chip 210 and a flow path formation substrate 204 (see FIG. 11B and the like).

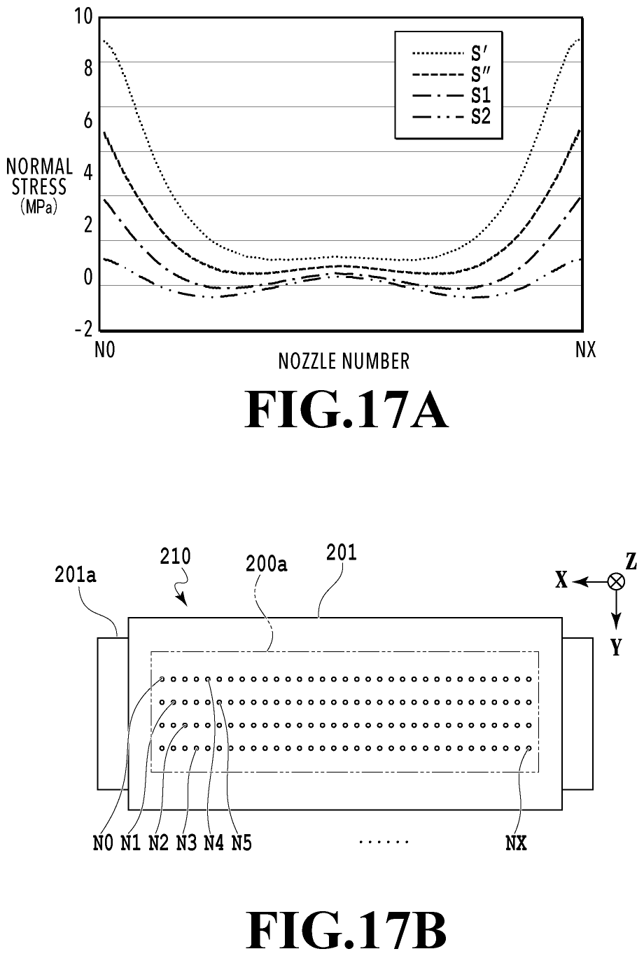

FIG. 17A is a graph showing simulation results of normal stresses generated in the liquid ejecting portion 200a according to the present embodiment. In FIG. 17A, the two-dotted chain line of S2 indicates a simulation result of a normal stress generated in the liquid ejecting portion 200a (see FIG. 16) in the present embodiment.

FIG. 17B is a schematic bottom view of the liquid ejection chip 210 that can be applied to the present embodiment.

As illustrated in FIGS. 17A and 17B, a value of a normal stress generated in the liquid ejecting portion 200a of the present embodiment is smaller than the value of the normal stress generated in the liquid ejecting portion 200a in the first embodiment.

Moreover, the difference between the normal stress value at the center portion and the normal stress values at both end portions of the liquid ejecting portion 200a in the present embodiment is also smaller than that in the first embodiment. In this manner, it is possible to further reduce the difference between the normal stress value of the first adhesive agent layers 701a and the normal stress value of the second adhesive agent layers 702a in the present embodiment.

Therefore, according to the liquid ejection chip 210 of the present embodiment, it is possible to further suppress degradation of liquid ejection performance as compared with the first embodiment.

### Other Embodiments

Examples to which the technology of the present disclosure can be applied have been described hitherto. However, the above description is not intended to limit the technical scope of the present disclosure.

The above embodiments have been specifically described by exemplifying an inkjet printing head and an inkjet printing apparatus that eject ink. However, the range to which the technology of the present disclosure can be applied is not limited thereto.

The liquid ejection head and the liquid ejection apparatus of the present disclosure can be applied to a printer, a copy machine, a facsimile equipped with a communication system, an apparatus equipped with a printer section such as a word processor, and an industrial printing apparatus combined with various processing devices in a complex manner. For example, the liquid ejection head and the liquid ejection apparatus of the present disclosure can also be used for applications to produce biochips, print electronic circuits, and the like.

In the above-described embodiments, a scheme of ejecting a liquid through driving of the piezoelectric element has been adopted. However, it is also possible to apply the technology of the present disclosure to liquid ejection heads that adopt a thermal scheme in which a liquid is ejected by air bubbles generated by a heater element and other various liquid ejection schemes.

The above-described embodiments have illustrated the inkjet printing apparatus in the form in which a liquid such as ink is circulated between the tank and the liquid ejection head. However, inkjet printing apparatuses in other forms may be used. For example, an inkjet printing apparatus in a form in which two tanks are provided on an upstream side and a downstream side of a liquid ejection head and ink inside pressure chambers is caused to flow by causing the ink to flow from one tank to the other tank without circulating the ink may be used.

The above-described embodiments have illustrated the liquid ejection apparatus 10 including the so-called full-line-type liquid ejection head 100. However, the technology of the present disclosure can also be applied to a liquid ejection apparatus that performs printing by ejecting a liquid to a printing medium P by a liquid ejection head that performs scanning in a scanning direction intersecting a transporting direction of the printing medium P in a plane. In other words, the technology of the present disclosure can also be applied to a liquid ejection apparatus including a so-called serial liquid ejection head.

According to the liquid ejection head of the present disclosure, it is possible to suppress degradation of liquid ejection performance.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-224002, filed Dec. 19, 2024, which is hereby incorporated by reference herein in its entirety.

What is claimed is:

1. A liquid ejection chip comprising:
a first substrate in which nozzle configured to eject a liquid supplied from a liquid supply member configured to supply the liquid are formed; and
a second substrate in which connection flow path connected to a supply flow path formed in the liquid supply member are formed,
wherein a first adhesive agent layer including a first adhesive agent and second adhesive agent layers including a second adhesive agent are provided on a bonding surface of the second substrate bonded to the liquid supply member,
the second substrate includes projecting portions projecting in a first direction more than the first substrate in a state where the liquid ejection chip is seen from a direction perpendicular to the bonding surface, and
the second adhesive agent layers are provided at the projecting portions.

2. The liquid ejection chip according to claim 1,
wherein the first adhesive agent layer is provided near the connection flow path and at a position at which the first adhesive agent layer overlaps the nozzle in a state where the liquid ejection chip is seen from a direction perpendicular to the bonding surface.

3. The liquid ejection chip according to claim 1,
wherein physical property values of the first adhesive agent layer and physical property values of the second adhesive agent layers are different from each other.

4. The liquid ejection chip according to claim 3,
wherein a coefficient of linear expansion of the first adhesive agent layer and a coefficient of linear expansion of the second adhesive agent layers are different from each other.

5. The liquid ejection chip according to claim 4,
wherein the coefficient of linear expansion of the first adhesive agent is equal to or greater than 1.2 times the coefficient of linear expansion of the second adhesive agent.

6. The liquid ejection chip according to claim 4,
wherein the coefficient of linear expansion of the second adhesive agent is equal to or greater than 1.2 times the coefficient of linear expansion of the first adhesive agent.

7. The liquid ejection chip according to claim 3,
wherein an elastic coefficient of the first adhesive agent layer and an elastic coefficient of the second adhesive agent layers are different from each other.

8. The liquid ejection chip according to claim 7,
wherein the elastic coefficient of the first adhesive agent is equal to or greater than 1.2 times the elastic coefficient of the second adhesive agent.

9. The liquid ejection chip according to claim 7,
wherein the elastic coefficient of the second adhesive agent is equal to or greater than 1.2 times the elastic coefficient of the first adhesive agent.

10. The liquid ejection chip according to claim 1,
wherein the first adhesive agent has higher liquid resistance than the second adhesive agent.

11. The liquid ejection chip according to claim 10,
wherein the first adhesive agent is a thermosetting adhesive agent, and
the second adhesive agent is a UV curable adhesive agent, a two-component-mixed adhesive agent, or an anaerobic curing adhesive agent.

12. The liquid ejection chip according to claim 1,
wherein the first adhesive agent and the second adhesive agent are thermosetting adhesive agents, and
a temperature at which the second adhesive agent is cured is lower than a temperature at which the first adhesive agent is cured.

13. The liquid ejection chip according to claim 1,
wherein in the first direction in a state seen from a direction perpendicular to the bonding surface, the liquid supply member is longer than the second substrate, and a distance by which the second substrate projects from end portions of the first substrate is equal to or greater than ½ times and less than 1 time the distance by which the liquid supply member projects from the end portions of the first substrate.

14. The liquid ejection chip according to claim 1,
wherein the second adhesive agent layers are provided at both end portions of the projecting portions in a second direction intersecting the first direction in a plane.

15. The liquid ejection chip according to claim 14,
wherein each of the both end portions is included within a virtual circle having, as a radius, a virtual straight line connecting a corner of each projecting portion and the nozzle that is closest to the corner in a plan view of the liquid ejection chip.

16. A liquid ejection head comprising: a liquid ejection chip configured to eject a liquid; and a liquid supply member configured to supply the liquid,
wherein the liquid ejection chip includes a first substrate in which nozzle configured to eject the liquid supplied from the liquid supply member configured to supply the liquid are formed and a second substrate in which connection flow path connected to supply flow path formed in the liquid supply member are formed,
a first adhesive agent layer including a first adhesive agent and second adhesive agent layers including a second adhesive agent are provided on a bonding surface of the second substrate bonded to the liquid supply member,
the second substrate includes projecting portions projecting in a first direction more than the first substrate in a state where the liquid ejection chip is seen from a direction perpendicular to the bonding surface, and
the second adhesive agent layers are provided at the projecting portions.

17. A manufacturing method of a liquid ejection unit that includes a liquid supply member configured to supply a liquid, and a liquid ejection chip including a first substrate in which nozzle configured to eject the liquid supplied from the liquid supply member are formed and a second substrate in which connection flow path connected to a supply flow path formed in the liquid supply member are formed, the manufacturing method comprising the steps of:
applying a first adhesive agent and a second adhesive agent to a bonding surface of the second substrate bonded to the liquid supply member;
bonding the liquid supply member to the liquid ejection chip with a position of the liquid supply member and a position of the second substrate being aligned; and
curing the first adhesive agent and the second adhesive agent,
wherein the second substrate includes projecting portions projecting in a first direction more than the first substrate in a state where the liquid ejection chip is seen from a direction perpendicular to the bonding surface, and
in the applying, the second adhesive agent is applied to the projecting portions.

18. The manufacturing method according to claim 17,
wherein in the applying, the first adhesive agent is applied near the connection flow path, and
in the bonding, the first adhesive agent is located at a position at which the first adhesive agent overlaps the nozzle in a state where the liquid ejection chip is seen from a direction perpendicular to the bonding surface.

19. The manufacturing method according to claim 17,
wherein physical property values of the first adhesive agent and physical property values of the second adhesive agent are different from each other.
